(19) United States
(12) Patent Application Publication
(10) Pub. No.: US 2005/0238855 A1
(43) Pub. Date: Oct. 27, 2005

(54) DEVICE FOR IDENTIFYING A BEVERAGE CONTAINER

(76) Inventor: Christopher Gerace, Newburyport, MA (US)

Correspondence Address: MESMER & DELEAULT, PLLC, 1 NEW HAMPSHIRE AVE., SUITE 125, PORTSMOUTH, NH, 03801, US

(21) Appl. No.: 10/907,932

(22) Filed: Apr. 21, 2005

Related U.S. Application Data
(60) Provisional application No. 60/521,418, filed on Apr. 22, 2004.

(51) Int. Cl. B32B 9/00

(52) U.S. Cl. 428/195.1

(57) ABSTRACT

A device that identifies a wine glass user and can communicate helpful information related to a gathering consists of a static cling vinyl label applied to the bottom of a glass that has a space for the user to write her name and pre-printed information related to the gathering. Devices can also be provided as a kit having a supply of static cling vinyl sheets and a computer template or organization for printing the devices and outlines onto the sheets.

### BACKGROUND

1. Field of the Invention

This invention relates devices used to communicate information about the contents of a container to which is applied.

2. Description of the Related Art

People often celebrate holidays and special occasions together with wine and champagne. The problem that inevitably arises is that people often forget which glass they were using. Most of the wine glasses look alike at a party, and a large number of glasses are set down and forgotten.

The solution before this invention was for a user to attach an identification charm to the wine glass stem. Presumably, each user at a gathering would have his/her own unique charm so that they cannot be confused with one another. However, the unique charm does not identify the user, and the user can easily forget which charm he/she had. The well-known effect of wine on one's memory compounds this pervasive problem. Furthermore, using a charm does not take advantage of a key opportunity to communicate information related to the gathering. Such information could be holiday greetings, birthday wishes, and such. What is needed, therefore, is a device that identifies the particular user of a wine glass while communicating helpful information related to the gathering.

### SUMMARY

A device that identifies a wine glass user and can communicate helpful information related to a gathering is a static cling vinyl label applied to the bottom of an object, such as a beverage glass, that has a space for the user to write his/her name and pre-printed information related to the gathering. These and other features, aspects, and advantages of the present invention will become better understood with regard to the following description and accompanying drawings.

### DRAWINGS

FIG. 1 is a side elevation of a wine glass with an identifying device applied to the bottom.

FIG. 2 is a plan view of the wine glass of FIG. 1.

FIG. 3 is a perspective view of the wine glass of FIG. 1 and FIG. 2.

### DESCRIPTION

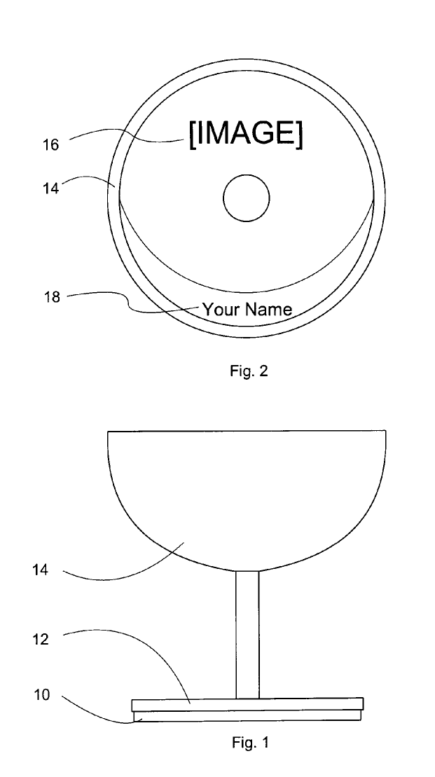

Turning to FIGS. 1, 2, and 3, a device that provides information about the object to which it is applied and can communicate helpful information related to the object is a static cling vinyl label 10 applied to the bottom of an object, such as a beverage glass 14 that has a space for the user to write his/her name 18 and pre-printed information related to the gathering 16. The device 10 is prepared first by printing a batch with the gathering information that is standard to the particular gathering onto a sheet of static cling vinyl. The sheet is preferably clear vinyl, but translucent and opaque vinyl can be used. The benefits of using static cling vinyl are a) it is waterproof, b) it does not have to be wetted to be applied to a glass, and c) it will not mark furniture, so that it acts as its own coaster, d) the product will not permanently stick to glassware, can be removed, saved, thrown away or placed on another glass with minimal effort.

Before use, a user is encouraged to write his/her name in the space provided 18. Then, the device 10 is simply pressed onto the bottom 12 of, for example, a wine glass 14.

As used herein, “information” 16 can be at least one of many different things. For example, information could be a holiday greeting, like “Season's Greetings,” or “Happy Birthday, John Doe,” or any other message selected by the host. The information could be advertising about a beverage, a restaurant, or other goods or services being promoted. Devices having advertising information may or may not have a space 18 for writing the user's name. Relevant art or photos can also be applied. The information is preferably applied using a printer attached to a computer, but other devices well known in the art could be used. A space 18 on the device is reserved for the user to write his/her name. The space can be indicated by a blank crescent shape to cue the user to write his/her name, or it can simply be a blank space on the device.

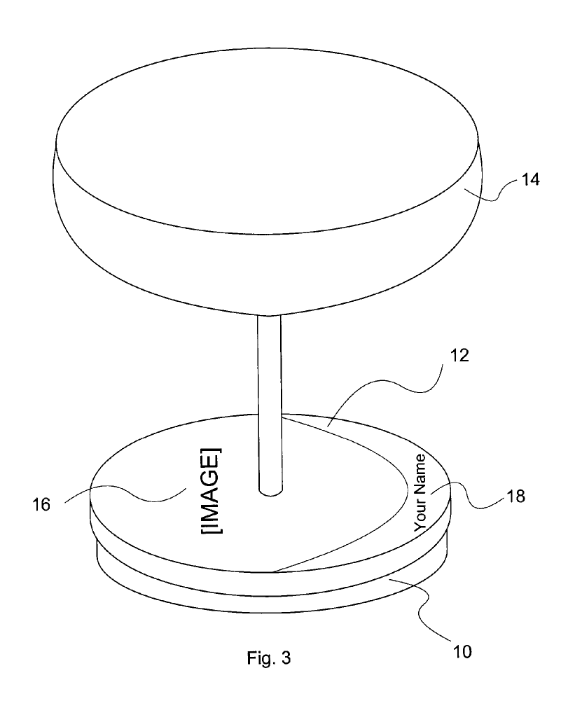

The devices 10 are then cut from the vinyl sheet with scissors or other means. A manufacturer preparing such devices in bulk may supply the vinyl devices on a backing that is kiss cut to cut the vinyl but not the backing. The preferred size is a circle having a diameter slightly less than that of the bottom of the wine glass 14 to be used, as is clearly shown in FIGS. 1 and 3. The benefit of having a smaller diameter is that the device 10 is less likely to be accidentally peeled off during handling. The device 10 also looks and behaves like it is a part of the glass 14.

One of the benefits of the invention is that the name 18 and gathering specific information 16 is clearly visible from the top of the glass when the glass is in the user's hand. Moreover, because many wine glass bottoms 12 are approximately convex, the bottoms 12 magnify the image on the device 10, which attracts the user's attention to the message.

Another embodiment is to provide devices 10 that fit the bottom of other types of glasses. The devices 10 can be adapted to fit the bottom of any glass having a substantially clear, or at least translucent, bottom. By glass, it is intended to include glass material and all types of plastic glasses.

Yet another embodiment of the invention is to provide a kit that will enable a user to make the devices 10. The kit would include at least one sheet of static cling vinyl, preferably of a size that would fit into a standard computer printer. The kit would also include a computer template or a computer application to facilitate printing the gathering specific information 16 on the device 10, and preferably for providing a space for printing one's name 18. Of course, the names can be pre-printed on a computer or the glass users can write them in. The computer user may be able to select the diameter of the device 10 needed for his/her glasses. Then the computer user can print out a plurality of devices 10 onto the sheet of vinyl, which will also come out with an outline of the devices on the vinyl page. The devices are then cut from the sheet with scissors, kiss cut, or other means. The computer template or application would be provided in the kit stored on a computer-readable device, such as a floppy disk, CD, or DVD, or downloadable from an online server.

Still another embodiment of the present invention is providing an Internet Web-based service, wherein users can design and purchase a supply of devices 10 online. The service would then print the devices 10 and mail them to the customer.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

1. A device for identifying the user of a beverage glass to which it is attached comprising:
a sheet of static cling vinyl attachable to a beverage glass bottom, the sheet being substantially the same size as the beverage glass bottom, the sheet comprising:
an information space; and
a blank crescent-shaped identification space adjacent to the information space.

2-6. (canceled)

7. The device of claim 1, wherein the sheet of vinyl is smaller than the bottom.

8. The device of claim 1, further comprising information in the information space.

9. The device of claim 1, further comprising artwork in the information space.

10-13. (canceled)

14. The device of claim 1, wherein the vinyl is transparent.

15. The device of claim 1, wherein the vinyl is opaque.

16. A kit for preparing a device that displays information about an object to which it is attached comprising:
a sheet of vinyl no thicker than can be printed upon in a computer printer; and
stored computer software capable of accepting information to be printed on the sheet of vinyl and capable of printing the information onto the sheet of vinyl, thereby preparing a device that displays information about an object to which it is attached.

17. The kit of claim 16, wherein the software is also capable of accepting information regarding the desired size of the device, and capable of organizing an output of a plurality of devices onto the sheet of vinyl.

18. The kit of claim 16, the stored computer software provided as one taken from the group consisting of a floppy disk, a CD, a DVD, or a source downloadble from an online server.

19. A method of making a device for displaying information about an object to which it is attached comprising the steps of:
inputting information to an online service about the size of a device attachable to an object;
inputting information to an online service related to an event at which the object may be used; and
printing the information related to the event on the device.

20. The method of claim 19, further comprising the step of shipping the device to a user.

21. The device of claim 9, wherein the artwork is a photograph

22. The device of claim 9, wherein the artwork is a greeting message relevant to the occasion.

23. The device of claim 9, wherein the artwork is a holiday greeting.

24. The device of claim 9, wherein the artwork is an advertisement.

25. The device of claim 1, further comprising identifying indicia of a user of the glass in the identification space.

26. The device of claim 25, wherein the identifying indicia is a user's name.

27. A device for identifying the user of a beverage glass to which it is attached comprising:
a sheet of static cling vinyl attachable to a beverage glass bottom , the sheet being substantially the same size as the beverage glass bottom, the sheet comprising:
a substantially crescent-shaped information space; and
an identification space having artwork adjacent to the information space, the artwork comprising at least one selected from the group consisting of a photo, a greeting relevant to the occasion, a holiday greeting, and an advertisement.

28. A device comprising:
a beverage glass having a bottom; and
a sheet of static cling vinyl attachable to a beverage glass bottom , the sheet being substantially the same size as the beverage glass bottom, the sheet comprising:
a substantially crescent-shaped information space; and
an identification space having artwork adjacent to the information space, the artwork comprising at least one selected from the group consisting of a photo, a greeting relevant to the occasion, a holiday greeting, and an advertisement.
